(19) United States
(12) Patent Application Publication
(10) Pub. No.: US 2024/0411848 A1
(43) Pub. Date: Dec. 12, 2024

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Takanari ISHIMURA, Kanagawa (JP)

(73) Assignee: FUJIFILM Business Innovation Corp., Tokyo (JP)

(21) Appl. No.: 18/517,414

(22) Filed: Nov. 22, 2023

(30) Foreign Application Priority Data
Jun. 13, 2023 (JP) 2023-097135

(51) Int. Cl. G06F 21/33; G06F 21/60

(52) U.S. Cl. CPC G06F 21/33; G06F 21/604

(57) ABSTRACT

An information processing system includes one or more processors configured to: receive a login from a user; extract identification information on the user from an identification (ID) token if an access token and the ID token that an authorization server has issued in response to a request from an external apparatus are acquired; and compare, with the identification information on the user extracted from the ID token, identification information on the user acquired when the login is received and permit access based on the access token if the identification information on the user acquired during the login matches the identification information on the user extracted from the ID token.

### CROSS-REFERENCE TO RELATED APPLICATIONS

This application is based on and claims priority under 35 USC 119 from Japanese Patent Application No. 2023-097135 filed Jun. 13, 2023.

### BACKGROUND

### (i) Technical Field

The present disclosure relates to an information processing system and a non-transitory computer readable medium.

### (ii) Related Art

Demand for modern authentication, such as OAuth authorization, is high to enhance security in data communications. In the issuance of an access token in response to a request in the OAuth authorization, a Web browser requests an authorization code from an authorization endpoint of an authorization server.

If a Web browser mounted on a device used in the data communications fails to support the authorization server, the authorization code used to issue the access token is difficult to obtain. In such a case, the authorization code may be obtained through another terminal having a Web browser operative with the authorization server.

Japanese Unexamined Patent Application Publication No. 2021-118437 discloses an information processing apparatus. The information processing apparatus has a Web browser function and a Web browser service that operates the Web browser function. The Web browser service creates a uniform resource locator (URL) used in an authorization process by receiving an authorization process request from a local application on the information processing apparatus and presents the created URL on a mobile terminal using the Web browser function. The information processing apparatus thus performs user authorization via the mobile terminal.

If a method of displaying on a screen is used to exchange information between one device performing data communications and another device operative with the authorization server, a third party may illegally acquire the information. Specifically, the information displayed on the screen may be stolen at a glance or illegally captured. This may lead to illegal acquisition of token information by spoofing.

### SUMMARY

Aspects of non-limiting embodiments of the present disclosure relate to controlling the illegal acquisition of token information via spoofing when information used to acquire the token information is exchanged between a device performing data communications and another device operative with an authorization server.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or more processors configured to: receive a login from a user; extract identification information on the user from an identification (ID) token if an access token and the ID token that an authorization server has issued in response to a request from an external apparatus are acquired; and compare, with the identification information on the user extracted from the ID token, identification information on the user acquired when the login is received and permit access based on the access token if the identification information on the user acquired during the login matches the identification information on the user extracted from the ID token.

### BRIEF DESCRIPTION OF THE DRAWINGS

Exemplary embodiment of the present disclosure will be described in detail based on the following figures, wherein:

FIG. 1 illustrates a configuration of an information processing system of an exemplary embodiment of the disclosure;

FIG. 2 illustrates a configuration of an image processing apparatus;

FIG. 3 illustrates a functional configuration of a controller;

FIG. 4 illustrates a hardware configuration of an authorization server;

FIG. 5 illustrates a hardware configuration of a terminal apparatus;

FIG. 6 illustrates an operation of a user login;

FIG. 7 illustrates another example of the operation of the user login;

FIG. 8 illustrates an operation of an administrator login; and

FIG. 9 illustrates another example of the operation of the administrator login.

### DETAILED DESCRIPTION

Embodiment of the disclosure is described in detail with reference to the attached drawings.

### System Configuration

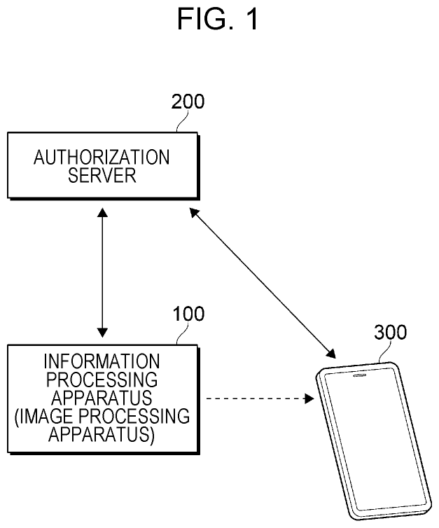

FIG. 1 illustrates the configuration of an information processing system of an exemplary embodiment of the disclosure. The information processing system includes an information processing apparatus 100, authorization server 200, and terminal apparatus 300. The information processing apparatus 100 is connected to the authorization server 200 via a network and the authorization server 200 is connected to the terminal apparatus 300 via a network (see arrow-headed solid lines in FIG. 1).

The information processing apparatus 100 performs a data processing process in response to an instruction of a user who has been authenticated. The information processing apparatus 100 performs not only user authentication process but also authenticates an execution instruction of a process in response to a token issued by the authorization server 200. The information processing apparatus 100 includes a display and has a screen display function in accordance with a Web browser. The information processing apparatus 100 may be one of variety of apparatuses, each including a computer as a controller. For example, the information processing apparatus 100 may be an image processing apparatus having a computer mounted as a controller. In the following discussion, the information processing apparatus 100 is an image processing apparatus. The information processing apparatus 100 is thus also referred to as an image processing apparatus 100.

The authorization server 200 provides a user with credential information in response to a request from the user. The credential information includes an authorization uniform resource locator (URL) and a user code. The authorization URL is a URL of an access destination used to request the authorization server 200 to perform authentication and issue a token. The user code is code data used in combination with the authorization URL and is information used to manage the token issued after the authentication.

The authorization server 200 performs user authentication in response to an authentication request based on the credential information and issues tokens used to perform a process on the image processing apparatus 100. The issued tokens include an access token that gives the image processing apparatus 100 authority to perform the process and an identification (ID) token on which authentication information on a user is recorded. The authentication information includes a user ID that is the identification information on the user. The user ID is identical to a user ID that the user uses to perform a login operation on the image processing apparatus 100 to be discussed below. The token is issued by the authorization server 200 in response to a Web browser that requests an authorization code from an authorization endpoint of the authorization server 200. The accessing to the authorization endpoint involves using the authorization URL provided as the credential information.

In order to be authenticated by the authorization server 200, the user uses the terminal apparatus 300. FIG. 1 illustrates only the single terminal apparatus 300 but the terminal apparatuses 300 are respectively held by multiple users who use the image processing apparatus 100. The terminal apparatus 300 includes a display and has a screen display function through the Web browser. The terminal apparatus 300 has an imaging unit that captures an image. The terminal apparatus 300 may be a smart phone, tablet terminal, laptop computer, or the like.

As previously described, the issuance of the token by the authorization server 200 is based on the Web browser requesting the authorization code. Also as previously described, the image processing apparatus 100 has the screen display function of the Web browser. If the Web browser of the image processing apparatus 100 with the version thereof does not support the authorization server 200, the image processing apparatus 100 is unable to acquire the token by accessing the authorization server 200. If the image processing apparatus 100 is an image processing apparatus having a computer serving as a controller, it may be difficult to keep the Web browser updated in view of system management. In this case, the terminal apparatus 300 having the Web browser operative with the authorization server 200 (as illustrated by arrow-headed broken line in FIG. 1) is provided with the credential information and is thus requested to issue the token.

As a method to exchange the credential information between the image processing apparatus 100 and the terminal apparatus 300, a screen including the credential information may be displayed on the image processing apparatus 100 and then photographed by the terminal apparatus 300. In such a case, however, a third party may steal a glance at or photograph the screen displayed on the image processing apparatus 100 and then may acquire the credential information. Such an unauthorized third party may thus acquire the token from the authorization server 200 and use the image processing apparatus 100. According to the exemplary embodiment, the image processing apparatus 100 has a unit controlling the use of the image processing apparatus 100 by the unauthorized third party. The control method is described below.

### Configuration of Image Processing Apparatus 100

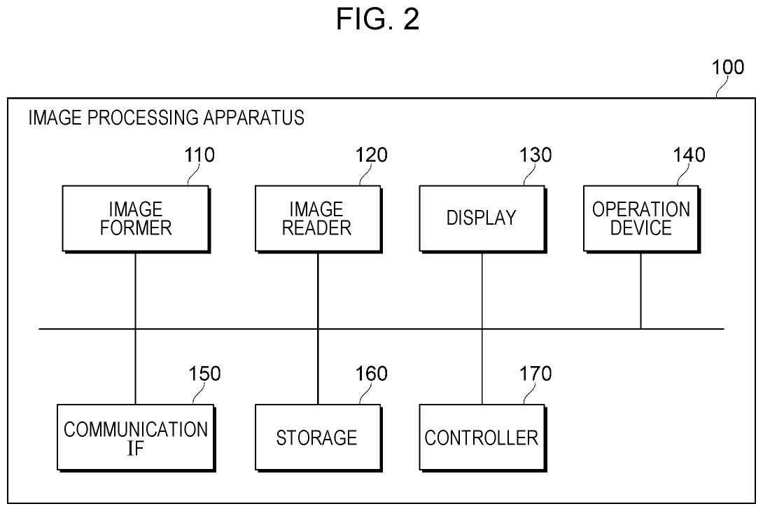

FIG. 2 illustrates the configuration of the image processing apparatus 100. The image processing apparatus 100 includes an image former 110, image reader 120, display 130, operation device 140, communication interface (IF) 150, storage 160, and controller 170.

The image former 110 forms, on a paper sheet serving as a recording medium, an image responsive to image data using an image forming material. Methods of forming the image on the recording material include an electrophotographic system that forms an image by transferring toner attached on a photoconductive body to the recording medium and an ink-jet method that forms an image by ejecting ink onto a recording material.

The image reader 120 includes a scanner, optically reads an image on a set original document, and generates data on the read image. The methods of image reading include a charge-coupled device (CCD) method that converges, through a lens, light reflected from an original document irradiated with light from a light source and a contact image sensor (CIS) method that receives light reflected from an original document irradiated with light from a light-emitting diode (LED) light source.

The display 130 displays information image providing a variety of information on a user, a pre-view image of an image serving as a processing target that is read or output, and an operation image that the user operates. The display 130 includes, for example, a liquid-crystal display. The display 130 and operation device 140 may be combined to form a user interface unit through which the user inputs information to and/or outputs information from the image processing apparatus 100.

The user uses the operation device 140 to enter a command and data. The operation device 140 includes a hardware key and a touch sensor that outputs a control signal responsive to a position that is pressed or touched by a finger of the user. The touch sensor and the liquid-crystal display forming the display 130 may be combined to form a touch panel.

The communication IF 150 exchanges a command and data with an external apparatus. The communication IF 150 may comply with a communication method that is operative with the external apparatus. The connection with the external apparatus may be implemented using a network or a direct connection. The communication network may be a wired network or a wireless network. If the image processing apparatus 100 has a fax function, the communication IF 150 includes an interface for telephone network.

The storage 160 stores a program executed by the controller 170 and data, data on an image read by the image reader 120, log data created through a variety of operations, and other kinds of data. For example, the storage 160 may be a magnetic disk, solid-state drive (SSD), or the like.

The controller 170 includes a processor serving as an arithmetic unit and a memory and performs a variety of functions described below by reading a program from the storage 160 onto the memory and executing the read program. For example, the processor may be a central processing unit (CPU), micro-processing unit (MPU), graphics processing unit (GPU), or digital signal processor (DSP). For example, the memory is a dynamic random access memory (DRAM).

### Functional Configuration of Controller 170

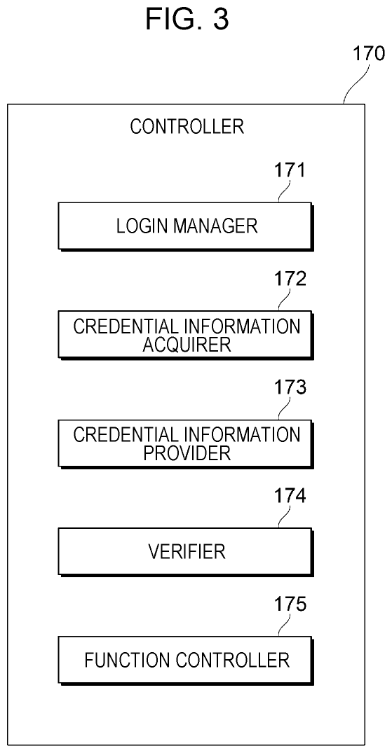

FIG. 3 illustrates the functional configuration of the controller 170. The controller 170 includes a login manager 171, confidential information acquirer 172, confidential information provider 173, verifier 174, and function controller 175.

The login manager 171 receives a login of a user on the image processing apparatus 100 and manages login information. The user performs the login by entering user information by operating the operation device 140 (login operation). If the entered user information matches pre-registered user information, the login manager 171 determines that the login is successful. The user information includes a user identification (ID) unique to the user and password. The login manager 171 stores on the storage 160 login information including the entered user information and time of the login and manages the login information. According to the exemplary embodiment, the login on the image processing apparatus 100 includes a login operation that is performed under user credentials in accordance with the user information on the user using the image processing apparatus 100 (hereinafter referred to as a “user login”) and a login operation that is performed under system credentials in accordance with the user information on the administrator of the image processing apparatus 100 (hereinafter referred to as an “administrator login”).

When the confidential information acquirer 172 receives the login from the user via the login manager 171, the confidential information acquirer 172 requests the authorization server 200 to issue the credential information and acquires the issued credential information. As previously described, the logins to the image processing apparatus 100 include the user login and the administrator login but the user login and the administrator login are not different from each other in terms of the credential information. The storage 160 in the image processing apparatus 100 stores information on the administrator and the controller 170 may recognize whether the credential information is acquired through the user login or the administrator login.

The confidential information provider 173 provides the user with the credential information acquired by the confidential information acquirer 172. The manner of providing the credential information may include displaying the credential information on the display 130, transmitting the credential information, or presenting the credential information using Web user interface (WebUI). The confidential information provider 173 provides the credential information by displaying on the display 130 an image indicating at least the authorization URL. When the authorization URL is displayed, the authorization URL may be displayed in text as it is or in a code image into which the authorization URL is two-dimensionally coded.

The confidential information provider 173 provides the user code in the credential information in a manner that is different depending on the login method to the image processing apparatus 100. If the login to the image processing apparatus 100 is the user login, the confidential information provider 173 provides the user code by displaying the user code on the display 130. The user code may be displayed in text as it is or and in a code image into which the user code and authorization URL are two-dimensionally coded.

In contrast, if the login to the image processing apparatus 100 is the administrator login, the confidential information provider 173 provides the user with the user code in a manner different from the manner of providing the authorization URL (displaying the authorization URL on the display 130). For example, the confidential information provider 173 may transmit an e-mail describing the user code to a user who has logged in (hereinafter referred to as a “login user”). The confidential information provider 173 may generate a data file describing the user code and allow the login user to reference the data file through WebUI operable by the login user. Since the login to the image processing apparatus 100 is the administrator login, the login user is the administrator.

The verifier 174 verifies whether the token issued by the authorization server 200 is based on an authorized issue request. This verification is performed if the login to the image processing apparatus 100 is the user login. The verifier 174 extracts a user ID from the ID token out of the tokens acquired from the authorization server 200 and determines whether the user ID matches the user ID entered at the login. If the two user IDs match each other, the verifier 174 determines that the token is based on the authorized issue request and if the two user IDs fail to match each other, the verifier 174 does not determine that the token is based on the authorized issue request.

The function controller 175 controls a variety of functions of the image processing apparatus 100. In response to the reception of the login, the function controller 175 performs communication control to acquire the credential information and token from the authorization server 200, displays the credential information for the user on the display 130, transmits the e-mail, and performs control on WebUI.

### Configuration of Authorization Server 200

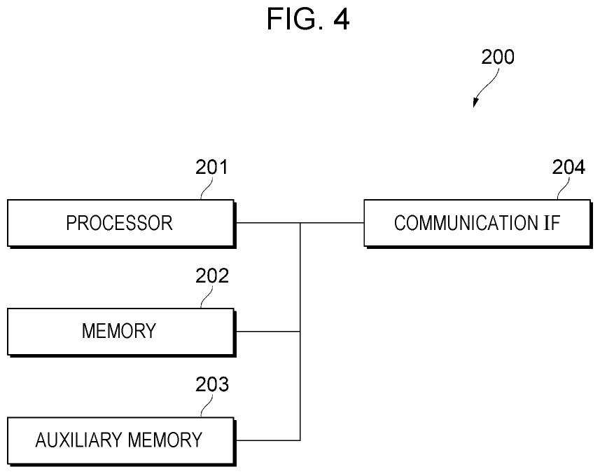

FIG. 4 illustrates the hardware configuration of the authorization server 200. The authorization server 200 is implemented by a computer illustrated in FIG. 4. The computer illustrated in FIG. 4 includes one or more processors 201 serving as an arithmetic unit, memory 202, and auxiliary memory 203. The processor 201 implements functions of the authorization server 200 by reading a program stored on the auxiliary memory 203 onto the memory 202 and executing the read program. The processor 201 may be a CPU, MPU, GPU, or DSP. The memory 202 may be a random-access memory (RAM). The auxiliary memory 203 may be a magnetic disk device or solid-state drive (SSD).

The computer illustrated in FIG. 4 includes a communication interface (IF) 204 that is used to connect to the image processing apparatus 100 or the terminal apparatus 300 via a network. The configuration of the computer illustrated in FIG. 4 is described for exemplary purposes only and the computer used in the exemplary embodiment may not be limited to the configuration of the computer illustrated in FIG. 4. For example, the memory may be a non-volatile memory, such as a flash memory, or a read-only memory (ROM). The authorization server 200 is not limited to the single computer illustrated in FIG. 4 and the functions of the authorization server 200 may be distributed among multiple computers or may be a cloud server constructed using resources on a cloud.

If the authorization server 200 is implemented by the computer illustrated in FIG. 4, the processor 201 implements the functions of the authorization server 200 by executing programs. The functions of the authorization server 200 include a function of providing the credential information in response to a request from the image processing apparatus 100, a function of performing user authentication in response to an authentication request responsive to the credential information, and a function of issuing a token in response to the results of the user authentication.

### Configuration of Terminal Apparatus 300

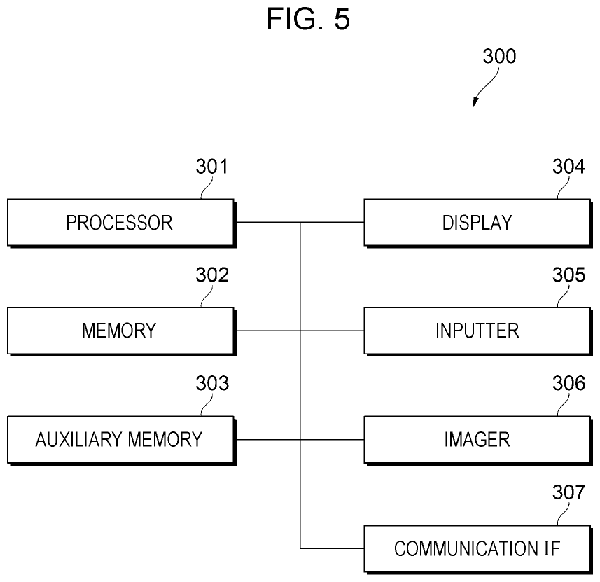

FIG. 5 illustrates the hardware configuration of the terminal apparatus 300. The terminal apparatus 300 is implemented by a computer illustrated in FIG. 5. The computer illustrated in FIG. 5 includes one or more processors 301 serving as an arithmetic unit, memory 302 and auxiliary memory 303. The processor 301 implements functions of the terminal apparatus 300 by reading a program stored on the auxiliary memory 303 onto the memory 302 and executing the read program. The processor 301 may be a CPU, MPU, GPU, or DSP. The memory 302 may be a RAM. The auxiliary memory 303 may be a magnetic disk device or SSD. A Web browser operative with the authorization server 200 is installed on the computer as the terminal apparatus 300.

The computer illustrated in FIG. 5 includes a display 304 that displays a variety of screens and an inputter 305 that a user operates to perform an input operation. The display 304 may include, for example, a liquid-crystal display. The inputter 305 includes, for example, a touch sensor. The touch sensor of the inputter 305 and the liquid-crystal display of the display 304 may be combined as a touch panel. The computer includes an imager 306 capturing an image. The imager 306 may be implemented by a camera having an image sensor. The computer includes a communication IF 307 used to connect to the authorization server 200 via a network. The configuration of the computer illustrated in FIG. 5 is illustrated for exemplary purposes only and the computer used as the terminal apparatus 300 is not limited to the configuration example illustrated in FIG. 5. For example, the memory may be a non-volatile memory, such as a flash memory or a ROM.

If the terminal apparatus 300 is implemented by the computer illustrated in FIG. 5, the processor 301 executes a program, thereby implementing the function of making the authentication request responsive to the credential information. Specifically, the processor 301 starts up the Web browser and the function of the Web browser makes the authentication request to the authorization server 200. In the computer serving as the terminal apparatus 300, the processor 301 implements the function of acquiring the credential information from the image processing apparatus 100 by executing the program and thus by controlling the imager 306 and the communication IF 307. Specifically, the credential information may be displayed on the display 130 in the image processing apparatus 100. When the imager 306 photographs the screen of the display 130 in the image processing apparatus 100, the processor 301 extracts the credential information from the photographed screen. If the user code out of the credential information is transmitted via an e-mail, the processor 301 extracts the user code from the e-mail received via the communication IF 307. If the user code out of the credential information is provided via WebUI, the processor 301 starts the Web browser, the Web browser receives a user operation on WebUI displayed on the display 304, and the user code is thus displayed on the display 304.

### Authentication Operation

An authentication operation when the user uses the image processing apparatus 100 is described below. The authentication operation is described with reference to a sequence diagram in which the image processing apparatus 100, authorization server 200, and terminal apparatus 300 are operative. In the following discussion, a terminal apparatus 300A is the terminal apparatus 300 that is used by the authorized user who has logged in on the image processing apparatus 100, and a terminal apparatus 300B is the terminal apparatus 300 that is used by a third party (unauthorized user) who has not logged in on the image processing apparatus 100. The terminal apparatus 300A and terminal apparatus 300B have the same functions.

### Operation of User Login

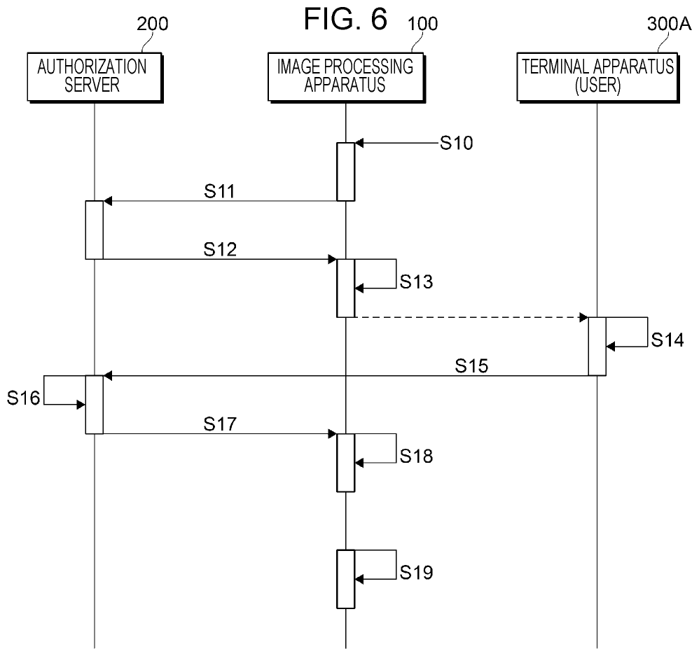

FIG. 6 illustrates an operation of the user login. In this operation example, an access token is issued in response to a request of an authorized user who has logged in on the image processing apparatus 100 and the image processing apparatus 100 is then used.

A login operation is performed in accordance with the user information on a user (the user ID and password) on the image processing apparatus 100 (S10). The image processing apparatus 100 receives the login operation and makes an issue request for the credential information to the authorization server 200 (S11). The authorization server 200 generates a user code in response to the request and returns as the credential information the user code together with the authorization URL (S12).

The image processing apparatus 100 presents the image of the credential information acquired from the authorization server 200 to the user by displaying the image on the display 130 (S13). The displaying of the credential information includes displaying a code image into which the authorization URL and user code are two-dimensionally coded or displaying only the authorization URL in the code image with the user code displayed in text. In another example, the authorization URL may be displayed in text with the user code displayed in the code image. In yet another example, both the authorization URL and the user code may be displayed in text.

Using the terminal apparatus 300A, the user photographs the image of the credential information displayed on the display 130 in the image processing apparatus 100. The terminal apparatus 300A extracts the authorization URL and user code from the photographed image of the credential information (S14). The user starts up the Web browser on the terminal apparatus 300A and accesses the authorization server 200 using the extracted authorization URL. The user enters the user code extracted from the credential information and the authentication information on the user (the user ID and password). The terminal apparatus 300A makes the authentication request by transmitting the entered user code and authentication information to the authorization server 200 (S15).

In response to the authentication request from the terminal apparatus 300A, the authorization server 200 identifies an issue event of the credential information in accordance with the user code and performs an authentication process in accordance with the authentication information acquired together with the user code (S16). If the authentication information acquired from the terminal apparatus 300A is registered on the system of the authorization server 200, the authorization server 200 issues and transmits an access token and ID token to the image processing apparatus 100 (S17). In this case, the authorization server 200 determines whether the authentication information is registered on the system of the authorization server 200 but does nothing about determining whether the user identified by the authentication information has logged in on the image processing apparatus 100.

The image processing apparatus 100 acquires the access token and ID token from the authorization server 200, extracts the user ID from the ID token, and determines whether the extracted user ID is identical to the user ID entered in S10 (S18). The ID token is an ID token acquired after the image processing apparatus 100 presents the credential information to the user. Since the user having logged in on the image processing apparatus 100 has made the authentication request to the authorization server 200, the two user IDs are identical. The execution instruction to instruct the image processing apparatus 100 to perform a process is authenticated and the image processing apparatus 100 then performs a process thereof in response to an operation of the user (S19).

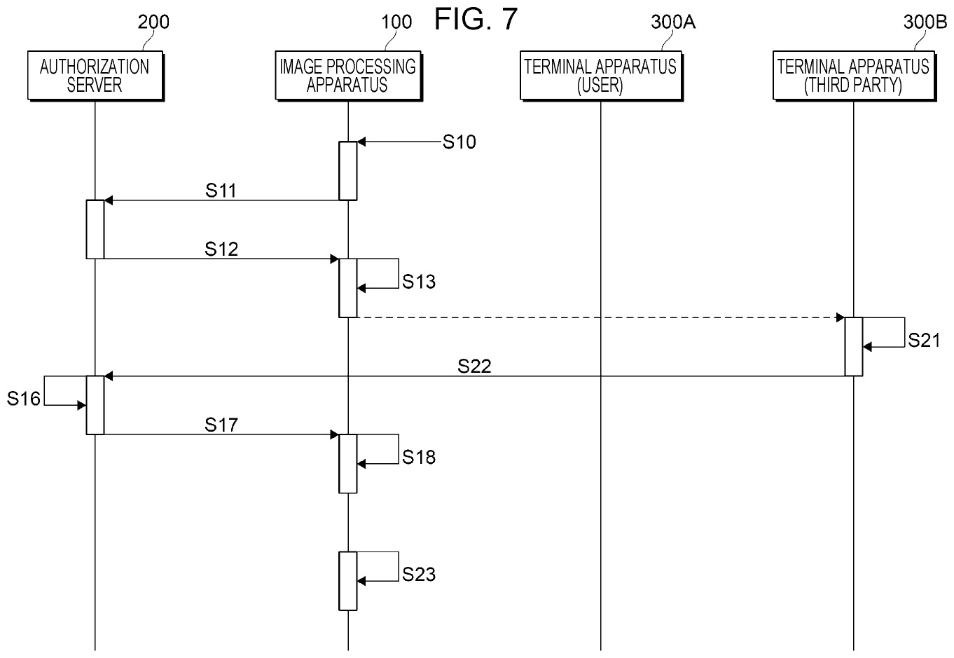

FIG. 7 illustrates another example of the operation of the user login. In this operation example, the access token is issued in response to a request of a third party (unauthorized user) different from the user who has logged in on the image processing apparatus 100C.

The operations (S10 through S13) in FIG. 7 from the login operation performed on the image processing apparatus 100 to the operation of the authorization server 200 providing the credential information to the operation of displaying the credential information on the image processing apparatus 100 are respectively identical the operations in FIG. 6. Using the terminal apparatus 300B, the third party different from the user who has logged in on the image processing apparatus 100 may now photograph the image of the credential information displayed on the display 130 in the image processing apparatus 100. The third party is not the person who has logged in on the image processing apparatus 100 in a series of operations but the authentication information on the third party is registered on the authorization server 200.

The terminal apparatus 300B extracts the authorization URL and the user code from the photographed credential information (S21). The third party starts up the Web browser on the terminal apparatus 300B and accesses the authorization server 200 using the extracted authorization URL. The third party enters the user code extracted from the credential information and the authentication information on the user (the user ID and password). The terminal apparatus 300B makes the authentication request by transmitting the entered user code and authentication information (S22).

In the same manner as in the authentication request performed by the authorized user as illustrated in FIG. 6, the authorization server 200 performs an authentication process in response to the authentication request from the third party (S16), issues the access token and ID token and transmits the access token and ID token to the image processing apparatus 100 (S17).

In response to the reception of the access token and ID token from the authorization server 200, the image processing apparatus 100 extracts the user ID from the ID token and determines whether the extracted user ID is identical to the user ID entered in S10 (S18). Since the third party, different from the user having logged in on the image processing apparatus 100, has made the authentication request to the authorization server 200, the two user IDs are different. The execution instruction to instruct the image processing apparatus 100 to perform a process is not accepted and the image processing apparatus 100 performs an error operation (S23).

If the user, different from the user having logged in on the image processing apparatus 100, has made the authentication request to the authorization server 200 in this way, user ID mismatch occurs and the credential information is determined to have been leaked. The unauthorized use of the access token is thus controlled. For example, the error operation in S23 includes displaying a message on the display 130 indicating that the user is not authorized to use the image processing apparatus 100 or notifying the administrator that the user code has been determined to have been leaked. The notification to the administrator may include the user ID extracted from the ID token.

### Operation of Administrator Login

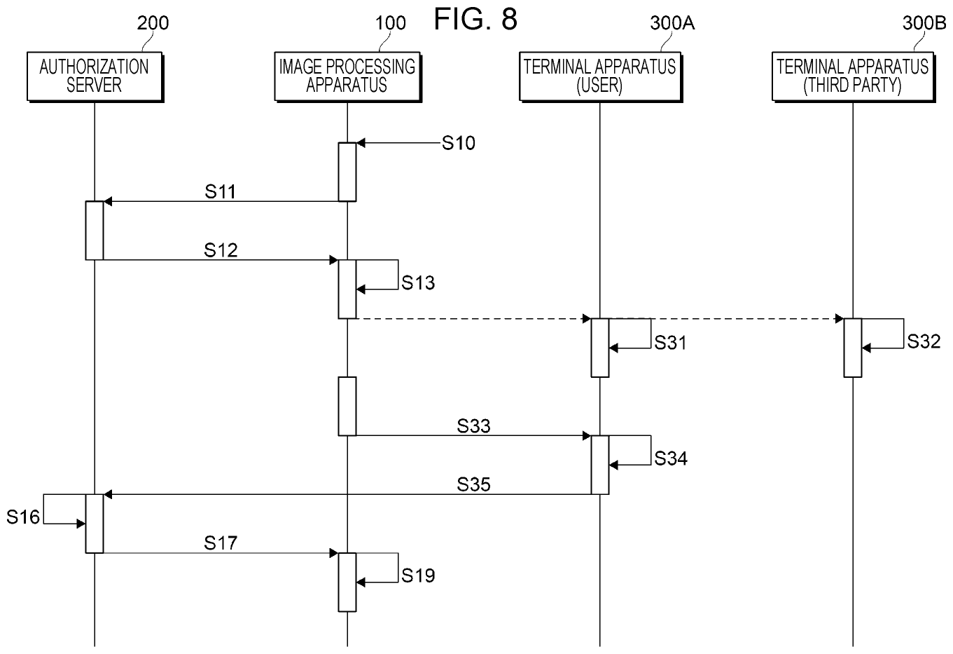

FIG. 8 illustrates an operation of an administrator login. The operations (S10 through S12) in FIG. 8 from the login operation performed on the image processing apparatus 100 to the operation of the authorization server 200 providing the credential information are respectively identical to the operations in FIG. 6. It is noted, however, that the login to the image processing apparatus 100 is performed using the user ID of the administrator.

The image processing apparatus 100 displays the image indicating the authorization URL on the display 130 out of the credential information acquired from the authorization server 200 and thus provides the user with the image (S13). The authorization URL may be displayed by displaying a code image that is obtained by two-dimensionally coding the authorization URL or by performing another coding method on the authorization URL or displaying the code image of only the authorization URL.

Using the terminal apparatus 300A, the user photographs an information indicating information on the authorization URL displayed on the display 130 in the image processing apparatus 100. The terminal apparatus 300A extracts the authorization URL from the photographed image (S31).

In a manner different from the manner of providing the authorization URL, the image processing apparatus 100 provides the user with the user code out of the credential information acquired from the authorization server 200. In this case, an e-mail describing the user code is transmitted to the terminal apparatus 300A (S33). In this operation example, the login to the image processing apparatus 100 is performed using the user ID of the administrator and the destination of the e-mail is the terminal apparatus 300 of the administrator. If the user having logged in on the image processing apparatus 100 is a user other than the administrator, the e-mail is to be transferred from the terminal apparatus 300 of the administrator to the terminal apparatus 300A.

In response to the reception of the e-mail from the image processing apparatus 100, the terminal apparatus 300A extracts the user code from the received e-mail (S34). The user starts up the Web browser on the terminal apparatus 300A and accesses the authorization server 200 using the authorization URL extracted in S31. The user enters the user code extracted in S34 and the authentication information of the user. The terminal apparatus 300A makes the authentication request by transmitting the entered user code and authentication information to the authorization server 200 (S35).

Using the terminal apparatus 300B, the third party, different from the user having logged in on the image processing apparatus 100, may now photograph the image indicating the information on the authorization URL displayed on the display 130 in the image processing apparatus 100 in S13. The terminal apparatus 300B of the third party extracts the authorization URL from the photographed image (S32). The image processing apparatus 100 does not transmit the e-mail describing the user code to the terminal apparatus 300B of the third party, who is not the administrator. For this reason, the third party may access the authorization server 200 using the authorization URL but is unable to make the authentication request to the authorization server 200.

In the same manner as in the operation example illustrated in FIG. 6, the authorization server 200 performs the authentication process in response to the authentication request from the terminal apparatus 300A (S16), issues the access token and ID token, and transmits the access token and ID token to the image processing apparatus 100 (S17).

In response to the reception of the access token and ID token from the authorization server 200, the image processing apparatus 100 performs a process responsive to an operation of the user in accordance with the acquired access token (S19). Since the third party unable to acquire the user code is unable to cause the authorization server 200 to issue the access token, the verification of the user ID (S18 in FIGS. 6 and 7) is not performed.

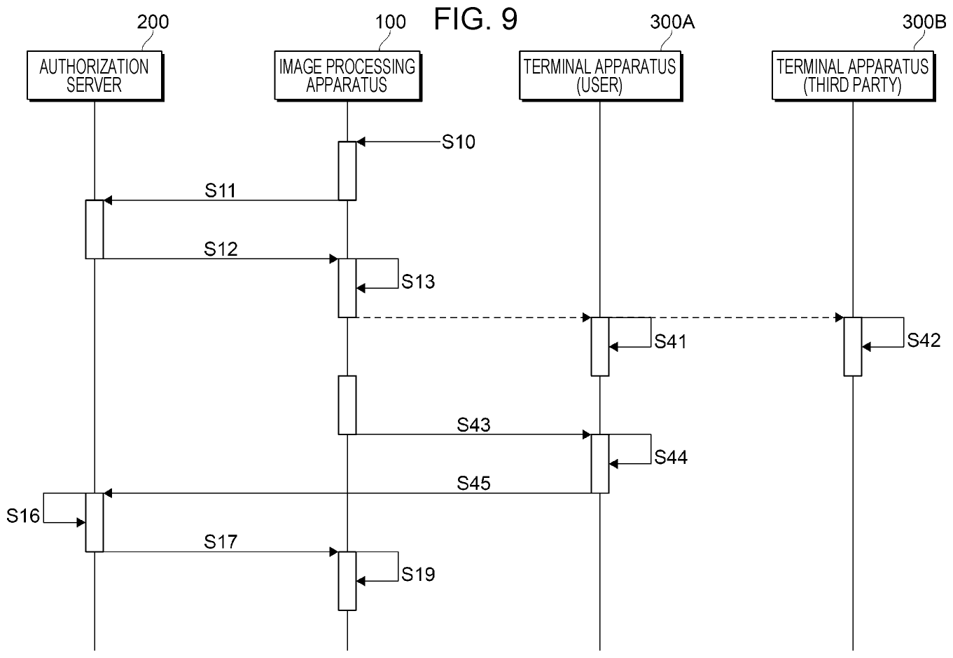

FIG. 9 illustrates another example of the operation of the administrator login. The operations (S10 through S13) in FIG. 9 from the login operation performed on the image processing apparatus 100 to the operation of the authorization server 200 providing the credential information to the operation of displaying the authorization URL out of the credential information on the image processing apparatus 100 are respectively identical the operations in FIG. 8.

Using the terminal apparatus 300A, the user photographs the image indicating the information on the authorization URL displayed on the display 130 in the image processing apparatus 100. The terminal apparatus 300A extracts the authorization URL from the photographed image (S41).

In a manner different from the manner of providing the authorization URL, the image processing apparatus 100 provides the user with the user code out of the credential information acquired from the authorization server 200. The image processing apparatus 100 generates a data file describing the user code and may be referenced through WebUI. The image processing apparatus 100 sends to the terminal apparatus 300A a notification that prompts the terminal apparatus 300A to acquire the user code through WebUI (S43).

When the terminal apparatus 300A receives the notification from the image processing apparatus 100, the user displays WebUI by starting up the Web browser on the terminal apparatus 300A and acquires the user code by operating the displayed WebUI (S44). Since the login to the image processing apparatus 100 is performed using the user ID of the administrator in this operation example, the destination of the notification is the terminal apparatus 300 of the administrator. If the user having logged in on the image processing apparatus 100 is a user other than the administrator, the administrator having acquired the user code by operating WebUI is to notify the user as the holder of the terminal apparatus 300A of the user code.

The user accesses the authorization server 200 from the Web browser of the terminal apparatus 300A using the authorization URL extracted in S41. The user enters the user code acquired in S44 and the authentication information of the user. The terminal apparatus 300A makes the authentication request by transmitting the entered user code and authentication information to the authorization server 200 (S45).

Using the terminal apparatus 300B, the third party, different from the user having logged in on the image processing apparatus 100, may now photograph the image indicating the information on the authorization URL displayed on the display 130 in the image processing apparatus 100 in S13. The terminal apparatus 300B of the third party extracts the authorization URL from the photographed image (S42). The image processing apparatus 100 does not make to the terminal apparatus 300B of the third party, who is not the administrator, the notification prompting the terminal apparatus 300B to acquire the user code through WebUI. For this reason, the third party may access the authorization server 200 using the authorization URL but is unable to make the authentication request to the authorization server 200.

In the same manner as in the operation example in FIG. 6, the authorization server 200 performs the authentication process in response to the authentication request from the terminal apparatus 300A (S16), issues the access token and ID token, and then transmits the access token and ID token to the image processing apparatus 100 (S17).

In response to the reception of the access token and ID token from the authorization server 200, the image processing apparatus 100 performs a process responsive to an operation of the user in accordance with the acquired access token (S19). Since the third party unable to acquire the user code is unable to cause the authorization server 200 to issue the access token in this operation example, the verification of the user ID (S18 in FIGS. 6 and 7) is not performed.

If a user other than the administrator uses the image processing apparatus 100 in the operation of the administrator login, the login is performed using the user ID of the administrator. For this reason, the user ID of the administrator is shared with a user who may use the image processing apparatus 100. During or prior to the login, the user going to use the image processing apparatus 100 notifies the administrator that the user is going to use the image processing apparatus 100 and requests the administrator to let the user know the user code. The user may thus acquire the user code provided by the image processing apparatus 100.

The exemplary embodiment of the disclosure has been described. The scope of the disclosure is not limited to the exemplary embodiment. For example, according to the exemplary embodiment, the authorization URL and the user code in the credential information are provided to the user in different manners of providing. The authentication information on each user and a notification destination, such as an e-mail address of the user, are stored in an associated form on the image processing apparatus 100 and each user having logged in on the image processing apparatus 100 is provided with the user code via the corresponding e-mail and WebUI. The exemplary embodiment with a variety of modifications and changes incorporated therewithin may still fall within the scope of the disclosure as long as the resulting exemplary embodiment does not depart from the scope of the disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system including: one or more processors configured to: receive a login from a user; extract identification information on the user from an identification (ID) token if an access token and the ID token that an authorization server has issued in response to a request from an external apparatus are acquired; and compare, with the identification information on the user extracted from the ID token, identification information on the user acquired when the login is received and permit access responsive to the access token if the identification information on the user acquired during the login matches the identification information on the user extracted from the ID token.

(((2)))

In the information processing system according to (((1))), the processor is configured to: acquire an authentication uniform resource locator (URL) and a user code from the authorization server in response to the login; and provide the user with the authentication URL and the user code, extract the identification information on the user about the ID token acquired after the user is provided with the authentication URL and the user code, and compare the identification information on the user about the ID token with the identification information acquired during the login.

(((3)))

In the information processing system according to (((2))), the processor is configured to, as a manner of providing the user with the authentication URL and the user code, cause a display to display an image including information on the authentication URL and the user code.

(((4)))

In the information processing system according to one of (((1))) through (((3))), the processor is configured to, if the identification information on the user acquired when the login is received fails to match the identification information on the user extracted from the ID token, notify an administrator that information used to request from the authorization server the access token and the ID token is determined to have been leaked.

(((5)))

In the information processing system according to (((4))), the processor is configured to notify the administrator of the identification information on the user extracted from the ID token.

(((6)))

An information processing system including: one or more processors configured to: receive, from a user from among multiple users, a login that uses identification information shared by the users; acquire, from an authorization server in response to the login, an authentication uniform resource locator (URL) and a user code that are used to cause the authorization server to issue an access token and an identification (ID) token; and provide the user with the authentication URL and transmit information on the user code to the user in a manner different from a manner for the authentication URL.

(((7)))

In the information processing system according to (((6))), the processor is configured to, as a manner of providing the authentication URL, cause a display to display an image including information on the authentication URL.

(((8)))

In the information processing system according to (((7))), the processor is configured to transmit the user code to the user via an e-mail.

(((9)))

A program causing a computer to execute a process, the process including: receiving a login from a user; extracting identification information on the user from an identification (ID) token if an access token and the ID token that an authorization server has issued in response to a request from an external apparatus are acquired; and comparing, with the identification information on the user extracted from the ID token, identification information on the user acquired when the login is received and permitting access based on the access token if the identification information on the user acquired during the login matches the identification information on the user extracted from the ID token.

(((10)))

A program controlling a computer connectable to multiple networks and causing the computer to execute a process, the process including: receiving, from a user from among multiple users, a login that uses identification information shared by the users; acquiring, from an authorization server in response to the login, an authentication uniform resource locator (URL) and a user code that are used to cause the authorization server to issue an access token and an identification (ID) token; and providing the user with the authentication URL and transmitting information on the user code to the user in a manner different from a manner for the authentication URL.

What is claimed is:

1. An information processing system comprising:
one or more processors configured to:
receive a login from a user;
extract identification information on the user from an identification (ID) token if an access token and the ID token that an authorization server has issued in response to a request from an external apparatus are acquired; and
compare, with the identification information on the user extracted from the ID token, identification information on the user acquired when the login is received and permit access based on the access token if the identification information on the user acquired during the login matches the identification information on the user extracted from the ID token.

2. The information processing system according to claim 1, wherein the processor is configured to:
acquire an authentication uniform resource locator (URL) and a user code from the authorization server in response to the login; and
provide the user with the authentication URL and the user code, extract the identification information on the user about the ID token acquired after the user is provided with the authentication URL and the user code, and compare the identification information on the user about the ID token with the identification information acquired during the login.

3. The information processing system according to claim 2, wherein the processor is configured to, as a manner of providing the user with the authentication URL and the user code, cause a display to display an image including information on the authentication URL and the user code.

4. The information processing system according to claim 1, wherein the processor is configured to, if the identification information on the user acquired when the login is received fails to match the identification information on the user extracted from the ID token, notify an administrator that information used to request from the authorization server the access token and the ID token is determined to have been leaked.

5. The information processing system according to claim 4, wherein the processor is configured to notify the administrator of the identification information on the user extracted from the ID token.

6. An information processing system comprising:
one or more processors configured to:
receive, from a user from among multiple users, a login that uses identification information shared by the users;
acquire, from an authorization server in response to the login, an authentication uniform resource locator (URL) and a user code that are used to cause the authorization server to issue an access token and an identification (ID) token; and
provide the user with the authentication URL and transmit information on the user code to the user in a manner different from a manner for the authentication URL.

7. The information processing system according to claim 6, wherein the processor is configured to, as a manner of providing the authentication URL, cause a display to display an image including information on the authentication URL.

8. The information processing system according to claim 6, wherein the processor is configured to transmit the user code to the user via an e-mail.

9. A non-transitory computer readable medium storing a program causing a computer to execute a process comprising:
receiving a login from a user;
extracting identification information on the user from an identification (ID) token if an access token and the ID token that an authorization server has issued in response to a request from an external apparatus are acquired; and
comparing, with the identification information on the user extracted from the ID token, identification information on the user acquired when the login is received and permitting access based on the access token if the identification information on the user acquired during the login matches the identification information on the user extracted from the ID token.
